(19) United States
(12) Patent Application Publication
(10) Pub. No.: US 2007/0062860 A1
(43) Pub. Date: Mar. 22, 2007

(54) Fluid control device

(76) Inventor: Ronald A. McDowell, Tulsa, OK (US)

Correspondence Address: BRINKS HOFER GILSON & LIONE, P.O. BOX 10395, CHICAGO, IL, 60610, US

(21) Appl. No.: 11/229,032

(22) Filed: Sep. 16, 2005

(51) Int. Cl. B01D 29/00

(52) U.S. Cl. 210/497.01; 210/438; 210/484; 210/503

(57) ABSTRACT

A fluid control device includes a perforated tubular member and a first and second wrapper. The tubular member is disposed along an axial length of a separator element and includes a first end, a second end, and an outer surface. A flow outlet is disposed at the first end of the tubular member. The first wrapper is disposed on a first portion of the outer surface of the tubular member adjacent the flow outlet. The second wrapper is disposed on a second portion of the outer surface of the tubular member. The first and second wrappers provide different resistances to fluid flow. A portion of the outer surface of the tubular member adjacent the second end is free from wrapping.

### BACKGROUND

Separator/coalescer units may be used to remove water from a non-aqueous fluid. In one type of separator/coalescer, the separator is a cylindrical element disposed around a vessel outlet. The separator includes a hydrophobic media that is intended to filter out water. The conventional configuration for a separator locates the outlet area of the vessel at the end of the separator element. This creates a problem because the unrestrictive hydrophobic media typical of a separator does not provide enough resistance to generate uniform flow along the length of the element. Consequently, the majority of the fluid is drawn from the area in the immediate vicinity of the outlet, which causes the section of the separator element closest to the outlet to be overloaded with flow. This is detrimental to the performance of a separator due to the hydrophobic nature of the media. The high fluid velocities overcome the hydrophobic properties of the media and force water through the media and into the effluent stream. A previous method for addressing this problem involved decreasing the open area of the separator center support tube to make it more restrictive. However, this approach significantly increases the pressure loss across the element.

### SUMMARY

In one aspect, a fluid control device includes a perforated tubular member and a first and second wrapper. The tubular member is disposed along an axial length of a separator element and includes a first end, a second end, and an outer surface. A flow outlet is disposed at the first end of the tubular member. The first wrapper is disposed on a first portion of the outer surface of the tubular member adjacent the flow outlet. The second wrapper is disposed on a second portion of the outer surface of the tubular member. The first and second wrappers provide different resistances to fluid flow. A portion of the outer surface of the tubular member adjacent the second end is free from wrapping.

The foregoing paragraphs have been provided by way of general introduction, and are not intended to limit the scope of the following claims.

### BRIEF DESCRIPTION OF THE DRAWINGS

FIG. 1 shows a cutaway view of one embodiment of a fluid control device in a separator.

FIG. 2 is an exploded view of an embodiment of a fluid control device.

### DETAILED DESCRIPTION

The invention is described with reference to the drawings. The relationship and functioning of the various elements of this invention are better understood by the following detailed description. However, the embodiments of this invention as described below are by way of example only, and the invention is not limited to the embodiments illustrated in the drawings.

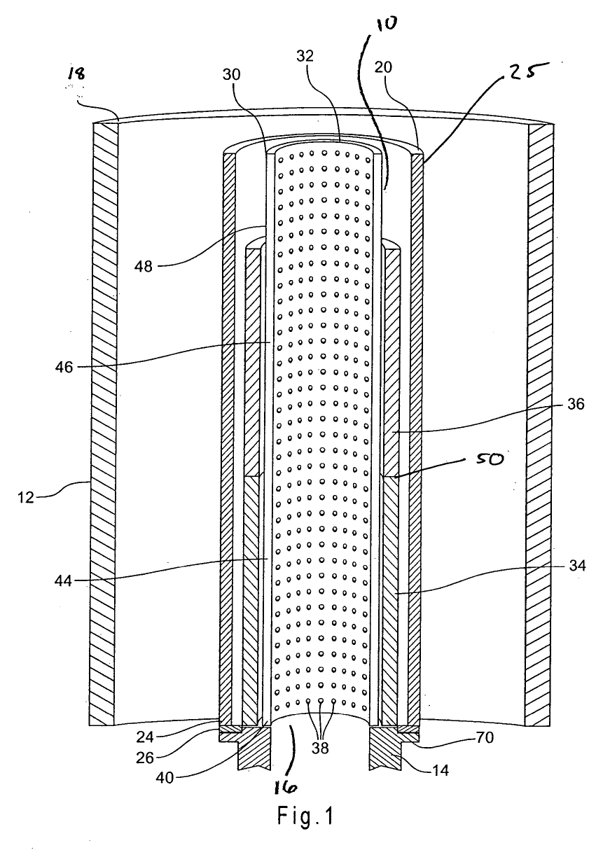

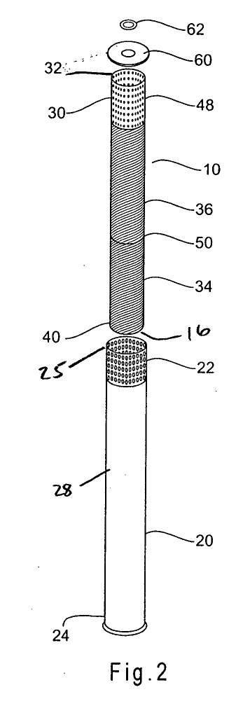

FIG. 1 shows a vessel 18 and a separator element 20. The vessel 18 has a vessel housing 12 with an outlet pipe 14. Disposed inside the vessel 18 is a cylindrical separator element 20. As seen in FIG. 2, the cylindrical separator element 20 includes a perforated shell 22 surrounded by hydrophobic separator material 28. An end cap 60 and gasket 62 seal the top opening of the separator 20. Disposed within the separator element 20 is a fluid control device 10. To exit through the outlet pipe 14, a fluid in the vessel 18 must pass through the separator element 20 and the fluid control device 10. In typical use, the vessel 18 contains a nonaqueous fluid and the separator element 20 is made of a hydrophobic media designed to separate water from the nonaqueous fluid.

As also seen in FIG. 2, the fluid control device 10 includes a perforated tubular member 30 adapted to be disposed along an axial length of a separator element 20. The tubular member 30 includes a first end 40, a second end 32, and a plurality of openings 38. The plurality of openings 38 are distributed along the circumference and length of the tubular member 30 to allow radial flow through the tubular member. The perforated tubular member 30 provides an open area of preferably between about 2% and about 10%, most preferably about 5%. A flow outlet 16 is disposed at the first end 40 of the tubular member 30.

The exterior of the tubular member 30 is covered by one or more wrappers, as exemplified by a first wrapper 34 and a second wrapper 36. The first and second wrappers 34, 36 serve to restrict the flow of fluid through the tubular member 30. In particular, the wrappers 34, 36 provide different resistances to fluid flow and serve to re-direct the flow so that it is more uniform along the axial length of the separator element 20. A first wrapper 34 is disposed on a first portion 44 of the outer surface of the tubular member 30 adjacent the flow outlet 16. A second wrapper 36 is disposed on a second portion 46 of the outer surface of the tubular member. A portion 48 of the outer surface of the tubular member 30 adjacent the second end 32 is free from wrapping. The first and second wrappers 34, 36 are disposed tightly against the outer surface of the tubular member 30.

The first wrapper 34 provides a greater resistance to fluid flow, or is more restrictive to fluid flow, than the second wrapper 36. The first wrapper 34 covers at least about 20% of the axial length of the tubular member 30, the second wrapper 36 covers at least about 20% of the axial length of the tubular member 30, and at least about 20% of the axial length of the tubular member is free from wrapping. In one embodiment, the first wrapper 34 is disposed along about 35% of the axial length of the tubular member 30, the second wrapper 36 is disposed along about 40% of the length of the tubular member 30, and about 25% of the tubular member 30 is uncovered. Alternatively, in one embodiment the ratio between the axial lengths of the first and second wrappers is between about 0.75 and 1.75, and the ratio between the axial lengths of the first wrapper and the uncovered portion is between about 0.75 and about 2.5.

The first wrapper 34 preferably covers the outer surface of the tubular member 30 all the way from the first end 40. The first and second wrappers 34, 36 preferably abut each other at seam 50 so that there is little or no open area of the tubular member between the two wrappers 34, 36. The two wrappers 34, 36 may also be fastened together at seam 50 by adhesive, fasteners, or other forms of bonding. However, a small uncovered portion between the first and second wrappers 34, 36 is acceptable so long as it does not affect the flow properties of the fluid control device 10.

The first and second wrappers 34, 36 may be made of any suitable material that can restrict fluid flow while still allowing fluid flow without a large pressure loss. The wrappers 34, 36 may be made from spunbonded polyester. The first wrapper 34 may have a density of about 2.0 to about 5.0 oz/yd², more preferably about 3.0 to about 4.0 oz/yd², and most preferably about 3.5 oz/yd². The first wrapper 34 may have a Frazier air flow porosity of density of about 300 to about 900 cfm, more preferably about 500 to about 700 cfm, and most preferably about 600 cfm. A suitable material for the first wrapper 34 is available from Colbond, Inc.

The second wrapper 36 may have a density of about 0.1 to about 1.5 oz/yd², more preferably about 0.3 to about 1.0 oz/yd², and most preferably about 0.5 oz/yd². The second wrapper 36 may have a Frazier air flow porosity of density of about 1100 to about 1700 cfm, more preferably 1300 to about 1500 cfm, and most preferably about 1400 cfm. A suitable material for the second wrapper 36 is available from Midwest Filtration. Both the first and second wrappers 34, 36 are preferably around 0.0010 inch to around 0.0020 inch thick.

The separator element 20 includes a hydrophobic media 28 that may be a hydrophobic treated synthetic screen or a Teflon coated wire screen. The bottom end 24 of the separator element 20 is sealed against the surface of the cartridge stool 70, which is part of the vessel 18. A gasket 26 may be disposed between the end 24 of the separator element 20 and the surface of the cartridge stool 70. A mounting flange (not shown) may also be used to secure the tubular member to the vessel housing.

In a standard separator in a coalescer/separator device, the hydrophobic media does not provide uniform flow along the length of the element; instead, the majority of the fluid is drawn from the area in the immediate vicinity of the outlet. The higher velocities overcome the hydrophobic properties of the media and force water through the media and into the effluent stream. The fluid control device 10 is used to create a more uniform velocity profile along the length of a relatively unrestrictive filtration element. A uniform velocity profile is believed to improve the liquid/liquid separation ability of a separator element. The first wrapper 34 preferably has the greatest flow resistance and thus reduces fluid flow in the area closest to the flow outlet 16, where the fluid velocity would otherwise be the greatest. The second wrapper 36 provides a slightly less resistance to flow in the middle portion 46 of the fluid control device 10. The unwrapped area 48 provides the least resistance to flow near the top end 25 of the separator, where there otherwise would be very little fluid flow. By increasing the resistance to flow in portions of the device 10, a more even distribution of flow is provided. High peak velocities are reduced and smoothed out to more effectively utilize the entire length of the separator. This prevents water droplets from being forced through the hydrophobic medium of the separator element 20.

As will be described below in the Example section, a separator in a coalescer/separator device using the flow control device 10 is capable of achieving less than 5 ppm water in the effluent in the fourth stage of API 1581 Fifth Edition qualification, and less than 10 ppm water in the effluent in the fifth stage of API 1581 Fifth Edition qualification.

The fluid control device 10 may be assembled as follows. The perforated tubular member 30 is prepared by any conventional method. Appropriately sized wrappers are fashioned into cylindrical forms from sheets of spunbonded polyester of the appropriate density and flow properties. The wrappers 34, 36 are then disposed on the outer surface of the tubular member 30. The wrappers 34, 36 are preferably held in place on the outer surface of the tubular member 30 by adhesive, such as a cyanoacrylate adhesive.

The elements of the fluid control device 10 may be made of any material suitable for the intended working environment. In one embodiment, the elements are made of steel. In another embodiment, the elements are made of aluminum. The fluid control device may have a single piece construction or may be multiple elements that are connected together.

Although the embodiments shown in FIGS. 1 and 2 include cylindrical elements with circular cross sections, it is apparent that this shape may be varied to include, for example, elliptical cross sections and any other shaped cross section that would produce the desired flow characteristics. Additionally, more than two wrappers may be used to provide an even more evenly distributed flow profile across the separator. For example, a third wrapper with less resistance to flow than the second wrapper 36 may be disposed between the second wrapper 36 and unwrapped surface 48 of the tubular member 30.

### EXAMPLE 1

A coalescer/separator unit was tested according to API 1581 5th Edition Specification and Qualification Procedures for Aviation Jet Fuel Filter/Separators (July 2002), the contents of which are incorporated herein by reference. Three tests were conducted. The first test did not include a fluid control device and was conducted in a horizontal vessel equipped with 10 coalescers and three separators at a fuel flow rate of 1543 gpm. A second test used fluid control devices in a horizontal vessel equipped with seven coalescers and two Teflon coated wire screen separators at 1000 gpm. A third test used fluid control devices in a horizontal vessel equipped with seven coalescers and two synthetic screen separators at 1170 gpm. Thus, each test had comparable fluid flow rates per separator in the range of 500 to 585 gpm. The testing is designed to measure the capability of a separator to remove water from jet fuel. The test, as described in section 4.4.5 in the Specification and Qualification Procedures for Aviation Jet Fuel Filter/Separators, consisted of five steps: media migration, water coalescence at 0.01% water addition, solids holding, a second 0.01% water addition, and 3% water addition. The maximum value that is acceptable for the testing procedure is 15 ppm water in the effluent.

The first phase of the test was media migration. This phase is designed to condition the coalescer elements. No water or dirt was added during this phase. A sample was taken at the end to look for media migration downstream. This phase lasted 30 minutes.

The second phase of the test was the water coalescence at 0.01% water addition. This is designed to give an indication of the performance of the coalescer/separator with clean elements. Water concentration readings were taken at 5, 10, 20, and 30 minutes and a Stop/Start (S/S) procedure was performed at 15 minutes and 30 minutes. The S/S procedure is designed to simulate the stopping and starting of fuel flow during a refueling process. The results of this phase of testing are shown in Table 1. It can be seen that both tests using fluid control devices resulted in a lower water concentration in the effluent than separators without fluid control devices. The separators with fluid control devices were able to achieve water concentrations of 1 ppm or less in both tests. Additionally, the pressure drop with the fluid control devices was comparable to the pressure drop without the fluid control devices.

TABLE 1
Second Phase: Water Coalescence at 0.01% Addition

| | | | Fluid control | | Fluid control | |
|---|---|---|---|---|---|---|
| | | | device #1 (Teflon | | device #2 | |
| | Standard | | coated wire | | (synthetic screen | |
| | Separator | | screen separator) | | separator) | |
| Fuel Flow | 1543 | | 1000 | | 1170 | |
| Rate (gpm) | | Water | | Water | | Water |
| Time | ΔP | Conc. | ΔP | Conc. | ΔP | Conc. |
| (min) | (psi) | (ppm) | (psi) | (ppm) | (psi) | (ppm) |
| 0 | 5.8 | — | 4.9 | — | 6.9 | — |
| 5 | 5.9 | 1.0 | 5.0 | 1.0 | 7.1 | 1.0 |
| 10 | 6.1 | — | 5.1 | 1.0 | 7.2 | 1.0 |
| 15 s/s | 6.3 | 1.0 | 5.2 | | 7.4 | |
| 20 | 6.5 | 1.5 | 5.4 | 1.0 | 7.5 | 1.0 |
| 30 | 6.7 | 3.0 | 5.7 | 1.0 | 7.9 | 1.0 |
| 30 s/s | 6.9 | 2.0 | 5.7 | | 8.0 | |

The third phase of the test was the solids addition. In this phase, a test dust was injected into the incoming fuel stream to contaminate the coalescers. No water was added during this phase and water concentration readings were not taken.

The fourth phase was a second 0.01% water addition. This is designed to give an indication of the performance of the coalescer/separators after having been exposed to solid contaminants. Water concentration readings were taken at 0, 2, 5, 15, 30, 45, 60, 75, and 90 minutes. Stop/start procedures were performed at the 30, 60, and 90 minute marks. The results of this phase of testing are shown in Table 2. It can be seen that both tests using the fluid control devices resulted in a lower water concentration in the effluent than separators without the fluid control devices. The fluid control devices were able to achieve water concentrations of less than 5 ppm in both tests. Additionally, the pressure drop with the fluid control devices in both tests was only slightly higher than without the fluid control devices.

TABLE 2
Fourth Phase: 0.01% Water Addition

| | | | Fluid control | | Fluid control | |
|---|---|---|---|---|---|---|
| | | | device #1 (Teflon | | device #2 | |
| | Standard | | coated wire | | (synthetic screen | |
| | Separator | | screen separator) | | separator) | |
| Fuel Flow | 1543 | | 1000 | | 1170 | |
| Rate (gpm) | | Water | | Water | | Water |
| Time | ΔP | Conc. | ΔP | Conc. | ΔP | Conc. |
| (min) | (psi) | (ppm) | (psi) | (ppm) | (psi) | (ppm) |
| 0 | 8.9 | — | 10.2 | — | 14.4 | — |
| 2 | — | | 10.4 | 1.0 | 14.6 | 1.0 |
| 5 | 9.2 | | 10.8 | 1.0 | 15.1 | 1.0 |
| 15 | 10.1 | 6.5 | 12.2 | 1.0 | 16.8 | 1.5 |
| 30 s/s | 10.9 | 2.5 | 13.2 | 1.0 | 17.7 | 1.5 |
| 45 | 11.4 | 8.0 | 13.8 | 1.0 | 18.6 | 1.5 |
| 60 s/s | 11.9 | 2.5 | 14.5 | 1.5 | 19.1 | 1.5 |
| 75 | 12.0 | 13.0 | 14.6 | 1.5 | 19.4 | 1.5 |
| 90 s/s | 12.3 | 6.0 | 14.9 | 1.5 | 19.5 | 1.5 |

The final phase increased the water injection rate to 3%. The results of this phase of testing are shown in Table 3. The water concentration in the standard separator went offscale at two minutes, meaning it was greater than the maximum instrument value, and the test was stopped. The fluid control devices were able to achieve water concentrations of less than 10 ppm in both tests.

TABLE 3
Fifth Phase: 3% Water Addition

| | | | Fluid control | | Fluid control | |
|---|---|---|---|---|---|---|
| | | | device #1 (Teflon | | device #2 | |
| | Standard | | coated wire | | (synthetic screen | |
| | Separator | | screen separator) | | separator) | |
| Fuel Flow | 1543 | | 1000 | | 1170 | |
| Rate (gpm) | | Water | | Water | | Water |
| Time | ΔP | Conc. | ΔP | Conc. | ΔP | Conc. |
| (min) | (psi) | (ppm) | (psi) | (ppm) | (psi) | (ppm) |
| 0 | 12.2 | | 14.9 | — | 19.5 | — |
| 2 | 16.5 | off scale | 21.0 | 1.5 | 22.3 | 9.0 |
| 5 | | | 22.9 | 2.0 | 23.3 | 9.0 |
| 10 | | | 25.5 | 4.0 | 24.9 | 8.5 |
| 15 | | | 28.0 | 6.0 | 25.6 | 9.5 |

From Tables 1, 2, and 3, it can be seen that the fluid control device according to the present invention produces a lower water concentration in the effluent than a separator without a fluid control device. The fluid control device according to the present invention was able to achieve water concentrations of less than 5 ppm in the fourth phase and less than 10 ppm in the fifth phase. Additionally, the pressure drop with the fluid control device according to the present invention is only slightly higher than without the fluid control device.

The embodiments described above and shown herein are illustrative and not restrictive. The scope of the invention is indicated by the claims rather than by the foregoing description and attached drawings. The invention may be embodied in other specific forms without departing from the spirit of the invention.

What is claimed is:

1. A fluid control device disposed along an axial length of a separator element, comprising:
a perforated tubular member comprising a first end, a second end, and an outer surface;
a flow outlet disposed at the first end of the tubular member;
a first wrapper disposed on a first portion of the outer surface of the tubular member adjacent the flow outlet; and
a second wrapper disposed on a second portion of the outer surface of the tubular member, wherein the first and second wrappers provide different resistances to fluid flow, and wherein a portion of the outer surface of the tubular member adjacent the second end is free from wrapping.

2. The device of claim 1 wherein the perforated tubular member provides between about 2% and about 10% open area.

3. The device of claim 1 wherein the first wrapper provides a greater resistance to fluid flow than the second wrapper.

4. The device of claim 1 wherein the first and second wrappers comprise spunbonded polyester.

5. The device of claim 1 further comprising an axial length, wherein the first wrapper covers at least about 20% of the axial length of the device, the second wrapper covers at least about 20% of the axial length of the device, and at least about 20% of the axial length of the device is free from wrapping.

6. The device of claim 1 wherein the first wrapper has a density of about 2.0 to about 5.0 oz/yd² and the second wrapper has a density of about 0.1 to about 1.5 oz/yd².

7. The device of claim 1 wherein the first wrapper has a density of about 3.0 to about 4.0 oz/yd² and the second wrapper has a density of about 0.3 to about 1.0 oz/yd².

8. The device of claim 1 wherein the first wrapper has a Frazier air flow porosity of density of about 300 to about 900 cfm and the second wrapper has a Frazier air flow porosity of density of about 1100 to about 1700 cfm.

9. The device of claim 1 wherein the first wrapper has a Frazier air flow porosity of density of about 500 to about 700 cfm and the second wrapper has a Frazier air flow porosity of density of about 1300 to about 1500 cfm.

10. A separator element assembly further comprising the separator element surrounding the device of claim 1.

11. The device of claim 10 wherein the separator element comprises a hydrophobic media.

12. A coalescer comprising the device of claim 11 capable of achieving less than 5 ppm water in the effluent in the fourth stage of API 1581 Fifth Edition qualification.

13. A coalescer comprising the device of claim 11 capable of achieving less than 10 ppm water in the effluent in the fifth stage of API 1581 Fifth Edition qualification.

14. A fluid control device disposed along an axial length of a separator element, comprising:
a perforated tubular member comprising a first end, a second end, and an outer surface;
a flow outlet disposed at the first end of the tubular member;
a first wrapper disposed on a first portion of the outer surface of the tubular member adjacent the flow outlet and covering at least about 20% of the axial length of the tubular member; and
a second wrapper disposed on a second portion of the outer surface of the tubular member adjacent a portion of the first wrapper and covering at least about 20% of the axial length of the tubular member, wherein at least about 20% of the axial length of the outer surface of the tubular member is free from wrapping adjacent the second end and wherein the first wrapper provides a greater resistance to fluid flow than the second wrapper.

15. The device of claim 14 wherein the first and second wrappers comprise spunbonded polyester.

16. The device of claim 14 wherein the first wrapper has a density of about 2.0 to about 5.0 oz/yd² and the second wrapper has a density of about 0.1 to about 1.5 oz/yd².

17. The device of claim 14 wherein the first wrapper has a Frazier air flow porosity of density of about 300 to about 900 cfm and the second wrapper has a Frazier air flow porosity of density of about 1100 to about 1700 cfm.

18. The device of claim 14 wherein the tubular member and the first and second wrappers are disposed within a separator element comprising a hydrophobic media.

19. A coalescer comprising the device of claim 14 capable of achieving less than 5 ppm water in the effluent in the fourth stage of API 1581 Fifth Edition qualification.

20. A coalescer comprising the device of claim 14 capable of achieving less than 10 ppm water in the effluent in the fifth stage of API 1581 Fifth Edition qualification.
